(19) United States
(12) Patent Application Publication
(10) Pub. No.: US 2022/0270097 A1
(43) Pub. Date: Aug. 25, 2022

(54) SYSTEM AND METHOD FOR PASSIVE AUTHENTICATION OF REMOTE USER TRANSACTIONS

(71) Applicant: City Hive Inc., New York, NY (US)

(72) Inventors: Roi KLIPER, New York, NY (US); Yosi DEDIASHVILI, New York, NY (US)

(73) Assignee: City Hive Inc., New York, NY (US)

(21) Appl. No.: 17/652,442

(22) Filed: Feb. 24, 2022

Related U.S. Application Data
(60) Provisional application No. 63/153,233, filed on Feb. 24, 2021.

(51) Int. Cl. G06Q 20/40; G06Q 20/34

(52) U.S. Cl. CPC G06Q 20/4015; G06Q 20/341; G06Q 20/40145

(57) ABSTRACT

A system and method of authenticating remote transactions is presented. The method includes: receiving a request to authenticate a remote transaction; collecting an authentication data feature through a sensor without notifying a user requesting the remote transaction; determining, based on the collected authentication data feature and an authentication profile if the user is physically located is at a designated location; and authorizing the remote transaction when the user is physically located at a designated location

### CROSS-REFERENCE TO RELATED APPLICATIONS

This application claims the benefit of U.S. Provisional Application No. 63/153,233 filed on Feb. 24, 2021, the contents of which are hereby incorporated by reference.

### TECHNICAL FIELD

The present disclosure relates generally to transaction authentication and, in particular, to systems and methods for passive authentication of remote transactions.

### BACKGROUND

As businesses, including retailers, service providers, and the like expand into online offerings, “card not present” (CNP) credit card transactions increasingly supplant in-person “card is present” (CIP) credit card transactions, as well as cash transactions. As a result of the increased potential for fraud in CNP transactions, arising from the inaccessibility of certain physical security features included in credit cards, such as authentication chips, credit card issuers may, when contracting with businesses to process credit card transactions, set transaction terms which reflect the increased potential for fraud. Specifically, credit card issuers may provide that merchants and businesses are not liable for losses incurred in fraudulent CIP transactions which are conducted in-person, but that the same merchants and businesses are liable in fraudulent CNP transactions.

FIGS. 1A and 1B, shown below, describe examples of CIP and CNP transaction environments, providing illustrative depictions of relationships between customers, merchants, and card issuers. FIG. 1A is an example network diagram depicting a transaction environment 100 for a “card is present” (CIP) credit card transaction, according to an embodiment. The transaction environment 100 includes a customer 110, a merchant 120, and a card issuer 130. While the merchant 120 and card issuer 130 are not shown as including various devices, systems, and components, as may be relevant to certain embodiments disclosed herein, it may be understood that the merchant 120, the card issuer 130, or both, may include various components, devices, or systems, without loss of generality or departure from the scope of the disclosure.

The customer 110 is a party to a transaction. The customer 110 seeks to pay the merchant 120, typically for goods or services provided by the merchant, using a credit card issued by the card issuer 130. The customer 110 may pay, using the credit card, by connecting the credit card to the merchant's 120 credit card reader, by means including, without limitation, swiping a magnetic strip, inserting a compatible card into a chip device, tapping a near-field connection device with the card, and the like. Where a customer 110 connects to a merchant's 120 credit card reader by those means described, a CIP transaction is effected, and customer 110 card data is collected by the merchant 120. Customer 110 card data includes various card data features including, without limitation, card number, expiration date, personal identification number (PIN), security code (also known as “CVV number”), customer 110 signature, and the like, as well as any combination thereof, which may be collected as data encoded in the card by the merchant's 120 card reader, entered by the customer 110 through a terminal, or the like, at the time of transaction, other, similar data features, and any combination thereof.

The merchant 120 may be a business, individual, or other, like, entity which collects payments from customers 110. Examples of merchants include, without limitation, retail stores, restaurants, service providers, utilities, and the like. The merchant 120 may, upon collecting customer 110 card data, relay one or more transaction data features to the card issuer 130 for processing, verification, or both. Transaction data features include, without limitation, the various card data features described herein above, a transaction amount, a transaction type, a transaction description, and the like, as well as any combination thereof.

The card issuer 130 is a business, individual, or other, like, entity, which collects transaction data from merchants 120 for transactions where a customer 110 pays with a credit card issued by the card issuer 130. Based on collected transaction data, the card issuer 130 may apply a charge for the amount of the transaction to the customer's 110 account, for which the customer 110 may be sent a bill. Further, the card issuer 130 may issue a payment to the merchant 120, such as a check or electronic bank transfer, equal to the amount of the transaction, less any agreed-upon transaction fees or charges, providing for payment of the merchant 120 by the card issuer 130, and subsequent payment of the card issuer 130 by the customer 110. The card issuer 130 may profit from such interactions by charging transaction fees to merchants 120, charging transaction interest to customers 110, and the like, as well as any combination thereof. The card issuer 130 may further authenticate or verify credit card transactions by providing various authenticating data features including, without limitation, registered card signatures, registered card data, other, like, data features, and any combinations thereof.

FIG. 1B is an example network diagram 160 depicting a transaction environment for a “card not present” (CNP) credit card transaction, according to an embodiment. The customer 110 and card issuer 130 of the CNP transaction environment may be similar or identical to those described with respect to FIG. 1A, above.

The remote merchant 140 is a merchant, similar to the merchant, 120, of FIG. 1A, above, where the remote merchant 140 is not geographically co-located with the customer 110. Examples of remote merchants 140 include, without limitation, online retailers, app-based ride-hailing or taxi services, online bill-payment services, and the like, as well as any combination thereof. The remote merchant 140 may be configured to complete a CNP transaction with a customer 110 by remotely collecting various customer and card data features including, without limitation, card numbers, card security codes, card expiration dates, cardholder zip or postal codes, customer names, customer addresses, and the like, as well as any combination thereof. Remote merchants 140 may be further configured to send transaction data, similar to that described with respect to FIG. 1A, above, to card issuers 130 for processing and verification, where such transaction data may include collected card and customer 110 data, transaction data, and the like.

In order to reduce the risk of fraud, credit card issuers include certain security features in credit cards to provide added security for CIP transactions. Many modern credit cards include near-field connection (NFC) components, allowing a customer to “tap” a card against a merchant's payment terminal to pay the merchant and verify the transaction. Further, many modern credit cards include integrated circuit “smart cards,” which a customer may insert into a designated reader to the same effect. In addition, credit cards may include additional physical security features such as holograms, which may be difficult to replicate, signature blocks, which may allow for a merchant to inspect and verify a customer's signature, and other, like features. However, while such features are effective in verifying CIP transactions, the card-bound nature of the features does not permit verification in CNP transactions. Further, modern credit card systems fail to provide mechanisms or sub-systems which provide for conversion of CNP transactions into CIP transactions, where such mechanisms or sub-systems may reduce merchant and issuer liability, may improve cardholder security, and may provide a lower-risk transaction process for all parties.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method of authenticating remote transactions, comprising: receiving a request to authenticate a remote transaction; collecting an authentication data feature through a sensor without notifying a user requesting the remote transaction; determining, based on the collected authentication data feature and an authentication profile if the user is physically located is at a designated location; and authorizing the remote transaction when the user is physically located at a designated location.

Certain embodiments disclosed herein also include a non-transitory computer readable medium having stored thereon causing a processing circuitry to execute a process, the process comprising: receiving a request to authenticate a remote transaction; collecting an authentication data feature through a sensor without notifying a user requesting the remote transaction; determining, based on the collected authentication data feature and an authentication profile, if the user is physically located is at a designated location; and authorizing the remote transaction when the user is physically located at a designated location.

Certain embodiments disclosed herein also include a system of authenticating remote transactions. The system comprises: a processing circuitry; and a memory, the memory containing instructions that, when executed by the processing circuitry, configure the system to: receive a request to authenticate a remote transaction; collect an authentication data feature through a sensor without notifying a user requesting the remote transaction; determine, based on the collected authentication data feature and an authentication profile, if the user is physically located is at a designated location; and authorize the remote transaction when the user is physically located at a designated location.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1A is a network diagram depicting a transaction environment for a “card is present” credit card transaction, according to an embodiment.

FIG. 1B is a network diagram depicting a transaction environment for a “card not present” credit card transaction, according to an embodiment.

FIG. 1C is a network diagram depicting a transaction environment for passive authentication of remote transaction according to an embodiment.

FIG. 2 is a flowchart depicting a method for performing passive authentication of remote user transactions, according to an embodiment.

FIG. 3 is an example schematic diagram of a transaction authentication device, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed embodiments of passive authentication of remote user transaction are described using an example of credit card transactions for illustrative purposes and is not a limitation. The example system and method disclosed herein may be utilized for other cases in which an authentication to a remote (or physically separate) agreement is desired. As an example, the disclosed embodiments may be utilized for authentication a remote reservation for a restaurant without financial commitment, authenticating student attendance, or the like,

The various disclosed embodiments include a method and system for passive authentication of remote user transactions. The embodiments disclosed herein enables decoupling of authorization and authentication of remote transactions by enabling a separate physical authentication. The physical authentication reduces the risk of transactions that are problematic in currently implemented methods of remote transactions. Moreover, authentication is performed automatically without customer proactively taking certain actions allowing rapid and passive authentication.

The various disclosed embodiments include herein further a method for identification and verification of access to payment instrument or method. The embodiments disclosed allow to de-couple the access to the payment method information from the location where the services are performed. In an embodiment, the method includes a protocol for initiating and accepting payment request from a remote transaction, and establishing a desired verification on the presence of payment method or person associated with or authorized to use payment method. The method for verifying payment method presence further includes re-initiating a payment request using verified information. The information can be verified, by requesting presence evidence, scanning for presence, and/or establishing presence between the physical location of a user and the payment method.

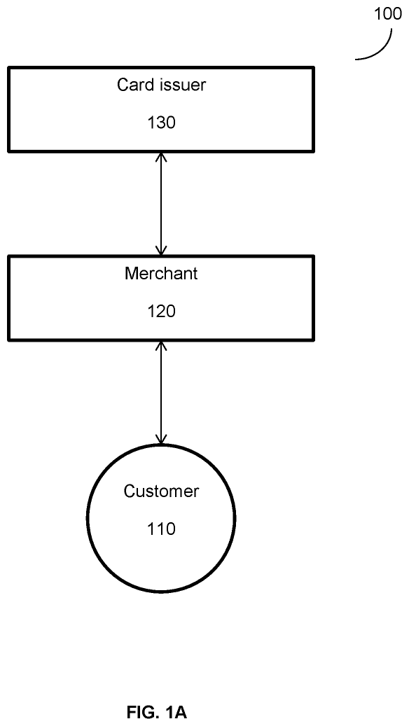

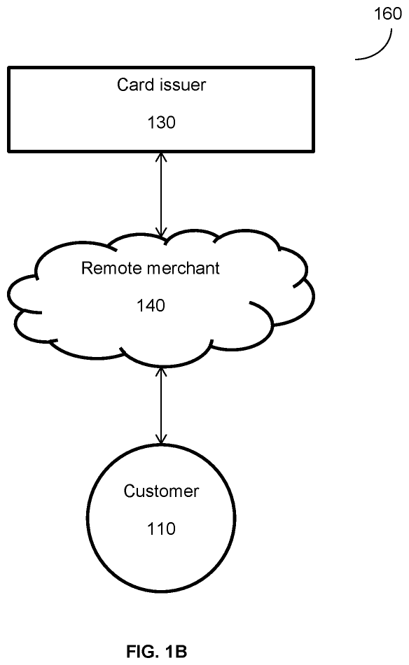

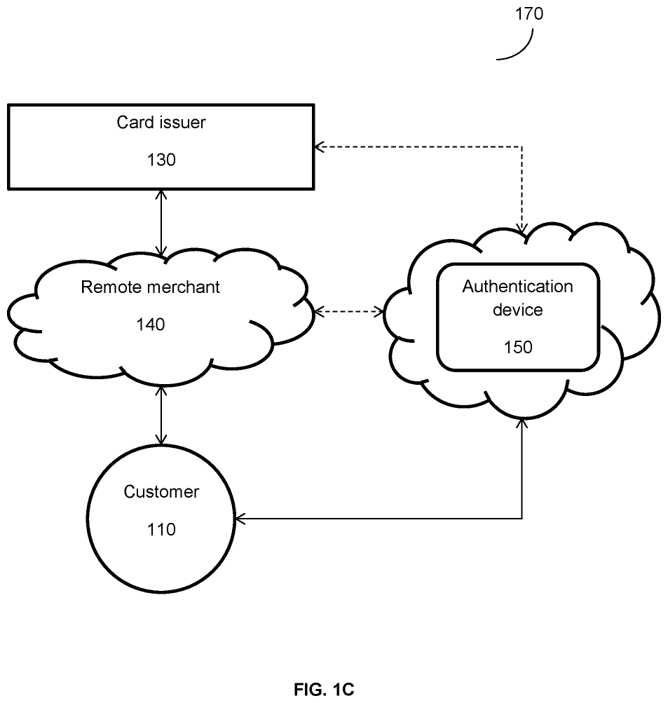

FIG. 1C is a network diagram 170 depicting a transaction environment for passive authentication of remote transaction according to an embodiment. A customer 110, a remote merchant 140, and a card issuer 130 of the passive authentication environment may be similar or identical to those described with respect to FIG. 1B, above. As noted above, the remote merchant 140 is not geographically co-located with the customer 110 and thus, configured to authorize a transaction from a customer 110 as, for example, a CNP transaction, without any further authentication. It should be noted that the disclosed embodiments are not limited to a CNP and applicable to any transaction that requires verification of a physical presence. For example, such verification is required for collection of valuable items ordered online, voting, and so on.

The authorization of transaction is based on various customer and card data features including, but not limited to, card numbers, card security codes, card expiration dates, cardholder zip or postal codes, customer names, customer addresses, and the like, as well as any combination thereof. Due to the geographically distant nature of the remote merchant 140, transaction authorization is performed without further authentication of the physical customer and/or card data features to result a high-risk transaction. A transaction data features including, but not limited to, the various card data features described herein above, a transaction amount, a transaction type, a transaction description, and the like, as well as any combination thereof, may be sent to the card issuer 130 and/or authentication device 150.

An authentication device 150 is a device, component, system, or the like, configured to collect one or more card authentication data features. Card authentication data features include data features which provide for card authentication by physical proximity which are not typically available in transactions executed with remote merchants 140. Card authentication data features may include, as examples and without limitation, near-field connection (NFC) signatures, radio-frequency identification device (RFID) signatures, cardholder facial identification signatures, biometric identification, cardholder voice identification signatures, and the like, as well as any combination thereof.

The authentication device 150 may be configured to collect card authentication data features by activation of one or more scanner, sensor, or similar components, and any combination thereof. Examples of components which may be included in an authentication device include, without limitation, NFC connectors or scanners, RFID connectors or scanners, microphones, cameras, digital signature pads, personal identification number (PIN) pads, and the like, as well as any combination thereof.

The authentication device 150 may be configured to interact with a customer 110 via one or more means to provide for collection of card authentication data features. As an example, an authentication device 150 may be configured to collect a photograph of a customer's 110 face, for purposes of facial identification verification, when a customer 110 enters a curbside pickup lane at a retailer's location, where the customer 110 has placed an order for curbside pickup.

The authentical device 150 may be configured to initiate collection of one or more card authentication data features automatically when the card or customer associated with the remote transaction is in the vicinity. The initiation of data collection may be performed without active involvement or action from the customer, and merely the presence within a predefined distance or location may be sufficient to enable passive authentication of the remote transaction. It should be noted that the passive authentication provides additional confirmation of the transaction reducing the risk and possibly fraud that may occur without such authentication, which may occur with only remote authorizations.

In addition, the authentication device 150 may be configured to connect with the remote merchant 140, the card issuer 130, or both, for purposes including, without limitation, collecting registered card authentication data features, transmitting card authentication data features, as collected from a customer 110, receiving authentication verification data, and the like, as well as any combination thereof. In a first example, an authentication device 150 may receive, corresponding with a remote transaction, a registered card authentication RFID signature and further match the registered card RFID signature with an RFID signature collected when the customer 110 approaches the authentication device 150. As a second example, an authentication device 150 may be configured to collect a customer's 110 card NFC signature when a customer enters an app-ordered taxi, and to transmit the collected card NFC signature to the card issuer 130 for verification. In further embodiment, the authentication device 150 may be configured to create a card authentication profile including, but not limited to, transaction authorization data and registered card authorization data features, associated with a specific card and/or remote transaction.

Moreover, the authentication device 150, connected to the remote merchant 140, may be configured to receive transaction authorization data from the remote merchant 140. The transaction authorization data may include, but not limed to, transaction data, card data, customer data, with respect to each remote transaction. The transaction authorization data may further include additional information relevant to authentication, for example, a time window or a geographical location (e.g., a store in a specific city) from which the authentication for the transaction is desired to be received by the authentication device 150.

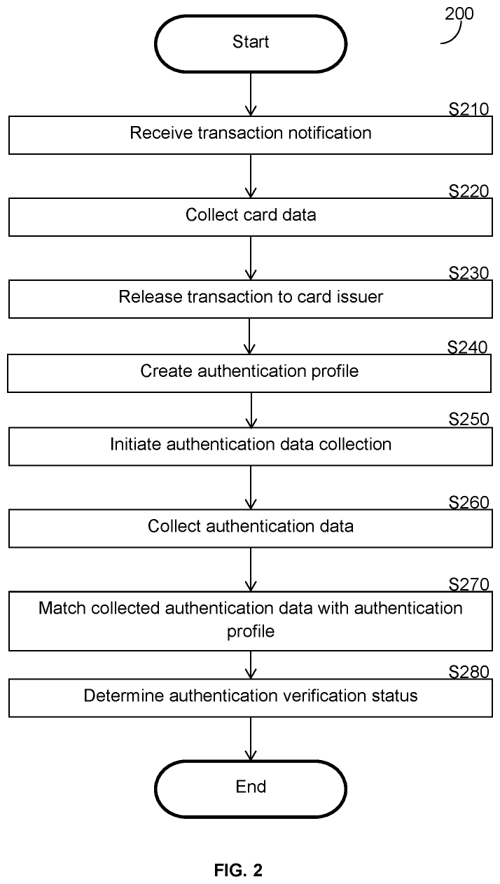

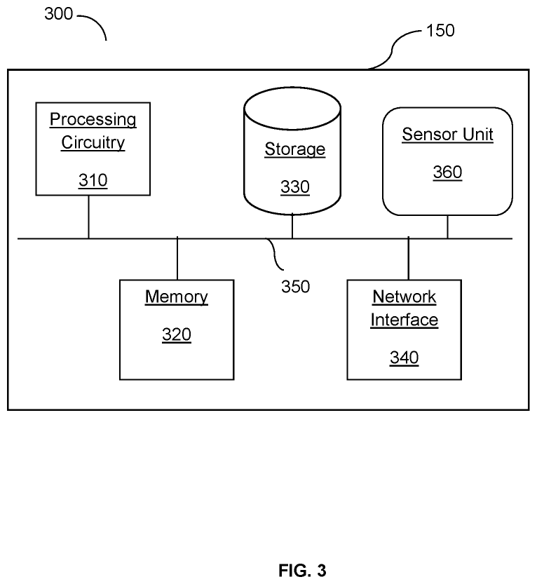

A method for authenticating remote transactions using an authentication device 150 is described with respect to FIG. 2, below. Further, a hardware block diagram of an authentication device 150, is described with respect to FIG. 3, below.

FIG. 2 is an example flowchart depicting a method for performing passive authentication of remote user transactions, according to an embodiment. The method described with respect to FIG. 2 may be executed by an authentication device, such as the authentication device 150 of FIG. 1C.

At S210, a transaction notification is received. The transaction notification may be received from one or more sources including, without limitation, card issuer systems, merchant systems, other, like, systems, and any combination thereof based on a remote transaction. The transaction notification may include one or more transaction data features describing the transaction including, without limitation, card issuer names and identifiers, merchant names or identifiers, transaction date and time, transaction amount, other, like, data features, and any combination thereof. In an embodiment, where a physical authentication is anticipated, such as, for example, where a customer places a mobile pickup order with a retailer, and where the retailer is equipped to provide physical authentication as described, the transaction notification may further include authentication data features describing, without limitation, an anticipated authentication time window, card authentication data features, other, like, data features, and any combination thereof.

At S220, card data is collected. Card data includes various data features relevant to the customer's card, including, without limitation, card numbers, cardholder names, card expiration dates, card security codes (also known as “CVV numbers”), cardholder addresses, cardholder zip or postal codes, card physical authentication values, other, like, data features, and any combination thereof. Card data may be collected from one or more sources including, without limitation, card issuer devices and systems, merchant devices and systems, customer input, other, like, sources, and any combination thereof.

At S230, transaction notification is released to the card issuer. Transaction notification includes one or more data features similar or identical to those included in the transaction notification received at S210, the card data collected at S220, or both, as well as other, like, data features, and any combination thereof. Transaction notification may be released to the card issuer by one or more systems or devices other than the authentication device, including, as an example and without limitation, merchant systems or devices. Where transaction notification is released to the card issuer by systems or devices other than the authentication device, S230 may include a “wait” or “hold” period between the executions of S220 and S250, during which the transaction notification is released to the card issuer.

At S240, an authentication profile is created. The authentication profile includes one or more data features for authentication of the remote transaction. In an embodiment, the authentication profile includes, but not limited to, card authentication data features and transaction authorization data. As an example, the authentication profile may include RFID signature, card snapshot, retina, fingerprint, anticipated time window, and the like, associated with the remote transaction to authenticate. In an embodiment, the authentication profile may define, using one or more data features, an expectation for authentication of a specific transaction.

At S250, authentication is initiated. The authentication, for example card scanning, includes the initiation of one or more resources for collecting card authentication data. In an example embodiment, card scanning may include, without limitation, activating wireless scanning components, such as near-field-connection (NFC) readers, Bluetooth connectors, radio-frequency identification device (RFID) scanners, and the like, activating image capture components, such as card snapshot cameras, cardholder facial identification cameras, and the like, activating other, like, components, such as signature readers, cardholder voice identification components, and the like, as well as activating other, like, card authentication data collection resources. In an embodiment, the initiation may be performed according to an initiation rule defining criteria for initiating collection of potential authentication data.

In an example embodiment, the physical authentication may be initiated automatically when a card authentication data is detected within a predefined vicinity of the authentication device. In another example embodiment, the authentication may be initiated when a customer enters a room having the authentication device. As an example, when a customer enters a delivery pick-up location, the fingerprint of the customer may be automatically collected from a surface, configured with the authentication device for authentication. In this case, the customer is not prompted to proactively provide authentication data, instead the authentication device is initiated upon detection of an authentication data feature to allow passive authentication of a user transaction.

In further embodiment, initiation of authentication data collection at S250 may include execution of the described actions according to one or more schedules or specifications. Initiation of authentication data collection at S250 according to one or more schedules or specifications may include, without limitation, selectively activating various of the described data collection components, initiating authentication data collection at specific times, activating authentication data collection in specific geographic locations, and the like, as well as any combination thereof. The one or more schedules or specifications may be pre-defined or user-defined, such as by a merchant, card issuer, and the like, and may further be collected, during the execution of S250, from one or more sources including, without limitation, the transaction notification received at S210, other, like, sources, and any combination thereof.

At S260, card authentication data features are collected. Card authentication data features may include, as examples and without limitation, card snapshots, card signatures or authentication values (e.g., RFID, NFC, etc.), cardholder signatures or authentication values (e.g., biometric identification, etc.), other, like, authentication data features, and any combination thereof. Authentication data may be collected by one or more resources including, without limitation, collection by those various components activated during authentication initiation at S250, by other, like, resources, and any combination thereof. As described with respect to S250, card authentication data collection at S260 may be executed according to one or more pre-defined or user-defined schedules or specifications. In an embodiment, in addition to card authentication data features, other data, such as, time stamp, location, and the like, with respect to the authentication may be collected. In an embodiment, the collected authentication data may be sent to systems or devices external to the authentication device, such as merchant systems and devices, card issuer systems and devices, or both, for authentication verification.

At S270, collected authentication data is matched with the authentication profile. The collected authentication data is compared to at least one data feature in the created authentication profile. The data features in the authentication profile include, but not limited to, registered card authentication data features and transaction authorization data that are specific to a certain remote transaction. In an embodiment, authentication may be verified when the collected authentication data successfully matches at least one data feature in the authentication profile, and thus, the card and/or customer of the remote transaction. In an embodiment, when matching is not successful, the authentication may be determined to be “not verified.”

As an example, where a customer places an online order for curbside pickup, the authentication device may be configured to compare a card RFID signature, collected as at S260, when the customer's vehicle enters a pickup lane, with a registered RFID signature received at S210 in the transaction notification. As another example, where a customer requests a taxi through a smartphone application, the authentication device disposed within the taxi may be configured to verify the authentication data features only where authentication data features are collected between the time when the customer enters the taxi and the time when the customer exits the taxi.

In another embodiment, authentication verification may be received from devices or systems external to the authentication device, such as card issuer systems or devices, merchant systems or devices, or both, where such systems and devices may be configured to compare authentication data features collected at S260 with registered authentication data features. In an embodiment, authentication may be verified according to one or more pre-defined or user-defined criteria including, as examples and without limitation, verification only where a collected card NFC signature matches a registered NFC signature, verification only where card authentication data is collected within thirty minutes of placing an online order, and the like, as well as any combination thereof.

At S280, the authentication verification status is determined and provided. The authentication verification status is determined based on matching of the authentication data at S270. In an embodiment, the authentication verification status may be determined based on a status determination rule which defines the criteria for determining verification based on matching of data features and predefined threshold values. In an embodiment, the authentication verification status may include, but not limited to, viability value, specific data feature used for verification, and more. The authentication verification status may be provided to merchant systems, card issuer systems, other, like, systems, and any combination thereof. Moreover, the authentication verification status may be provided to a customer, from which the authentication data was collected, through one or more resources of the authentication device or other devices communicatively connected to and capable of projection.

In an example embodiment, the “verified” authentication verification status provided to, for example, a card issuer, may lead to issuance of payment on the respective transaction. In an embodiment, when the authentication is “not verified,” a notification (or an alert) may be provided with the status. In further embodiment, the notification for “not verified” status may include instructions, commands, or the like, regarding the corresponding transaction. As an example, when the card issuer received a “not verified” status, the card issuer may decline the remote transaction and send a decline alert to the authentication device. As another example, when the card issuer received a “not verified” status, the card issuer may still process the remote transaction.

FIG. 3 is an example schematic diagram 300 of an authentication device 150, according to an embodiment. The authentication device 150 includes a processing circuitry 310 coupled to a memory 320, a storage 330, a network interface 340, and a sensor unit 360. In an embodiment, the components of the authentication device 150 may be communicatively connected via a bus 350.

The processing circuitry 310 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 320 may be volatile (e.g., random access memory, etc.), non-volatile (e.g., read only memory, flash memory, etc.), or a combination thereof.

In one configuration, software for implementing one or more embodiments disclosed herein may be stored in the storage 330. In another configuration, the memory 320 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 310, cause the processing circuitry 310 to perform the various processes described herein.

The storage 330 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 340 allows the authentication device 150 to communicate with the various components, devices, and systems described herein for authenticating “card not present” transactions, as well as other, like, purposes.

The sensor unit 360 provides for authentication device 150 functionalities including, without limitation, scanning for card authentication data features, collecting card authentication data features, interacting with card authentication data features, such as by communicating with card-bound programmed integrated circuit “smart cards,” and the like, as well as any combination thereof. The sensor unit 360 may be configured to provide the described functionalities using one or more integrated sensor or communication devices including, without limitation, NFC transmitters and receivers, RFID transmitters and receivers, signature pads, PIN pads, cameras, microphones, and the like, as well as any combination thereof. As described hereinabove, the sensor unit 360 may be configured to communicate with various components of the authentication device 150 via the bus 350.

It should be understood that the embodiments described herein are not limited to the specific architecture illustrated in FIG. 3, and other architectures may be equally used without departing from the scope of the disclosed embodiments.

In an embodiment, a method of authenticating remote transactions, comprising:

receiving a request to authenticate a remote transaction; collecting authentication data feature through a sensor without notifying a user requesting the remote transaction; determining, based on the collected authentication data feature and an authentication profile if the user is physically located is at a designated location; and authorizing the remote transaction when the user is physically located at a designated location.

In further embodiment, the remote transaction is a card-not-present (CNP) transaction.

In further embodiment, the designated location is where services paid through the remote transaction are provided.

In further embodiment, collecting authentication data feature through a sensor further comprises: initiating a card scanning based on scan criteria for activating the sensor.

In further embodiment, the scan criteria are predefined and includes any one of: time and geographic location.

In further embodiment, the authentication data feature includes: a card image signature, a near-field connection (NFC) signature, a radio-frequency identification device (RFID) signature, a facial identification signature, and a voice identification signature.

In further embodiment, the sensor is at least one of: wireless sensor device, image capturing device, and voice capturing device.

It should be noted that the computer-readable instructions may be construed broadly to mean any type of instructions, whether referred to as software, firmware, middleware, microcode, hardware description language, or otherwise. Instructions may include code, such as in source code format, binary code format, executable code format, or any other suitable format of code. The instructions, when executed by the circuitry, cause the circuitry to perform the various processes described herein.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (CPUs), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C In combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method of authenticating remote transactions, comprising:
receiving a request to authenticate a remote transaction;
collecting an authentication data feature through a sensor without notifying a user requesting the remote transaction;
determining, based on the collected authentication data feature and an authentication profile, if the user is physically located is at a designated location; and
authorizing the remote transaction when the user is physically located at a designated location.

2. The method of claim 1, wherein the remote transaction is a card-not-present (CNP) transaction.

3. The method of claim 2, wherein the designated location is where services paid through the remote transaction are provided.

4. The method of claim 2, wherein collecting the authentication data feature through the sensor further comprises:
initiating a card scanning based on scan criteria for activating the sensor.

5. The method of claim 4, wherein the scan criteria are predefined and includes any one of: time and geographic location.

6. The method of claim 4, wherein the authentication data feature includes: a card image signature, a near-field connection (NFC) signature, a radio-frequency identification device (RFID) signature, a facial identification signature, and a voice identification signature.

7. The method of claim 1, wherein the sensor is at least one of: wireless sensor device, image capturing device, and voice capturing device.

8. A non-transitory computer readable medium having stored thereon instructions for causing a processing circuitry to execute a process, the process comprising:
receiving a request to authenticate a remote transaction;
collecting an authentication data feature through a sensor without notifying a user requesting the remote transaction;
determining, based on the collected authentication data feature and an authentication profile, if the user is physically located is at a designated location; and
authorizing the remote transaction when the user is physically located at a designated location.

9. A system for authenticating remote transactions, comprising:
a processing circuitry; and
a memory, the memory containing instructions that, when executed by the processing circuitry, configure the system to:
receive a request to authenticate a remote transaction;
collect an authentication data feature through a sensor without notifying a user requesting the remote transaction;
determine, based on the collected authentication data feature and an authentication profile, if the user is physically located is at a designated location; and
authorize the remote transaction when the user is physically located at a designated location.

10. The system of claim 1, wherein the remote transaction is a card-not-present (CNP) transaction.

11. The system of claim 10, wherein the designated location is where services paid through the remote transaction are provided.

12. The method of claim 10, wherein the system is further configured to:
initiating a card scanning based on scan criteria for activating the sensor.

13. The method of claim 12, wherein the scan criteria are predefined and includes any one of: time and geographic location.

14. The method of claim 12, wherein the authentication data feature includes: a card image signature, a near-field connection (NFC) signature, a radio-frequency identification device (RFID) signature, a facial identification signature, and a voice identification signature.

15. The method of claim 9, wherein the sensor is at least one of: wireless sensor device, image capturing device, and voice capturing device.
